(19) United States
(12) Patent Application Publication
(10) Pub. No.: US 2012/0279714 A1
(43) Pub. Date: Nov. 8, 2012

(54) CHEMICAL LINE FLUSH SYSTEMS

(76) Inventors: Timothy Lesko, Sugar Land, TX (US); Noel Coffman, Houston, TX (US)

(21) Appl. No.: 13/100,609

(22) Filed: May 4, 2011

(51) Int. Cl. E21B 43/26; B08B 3/08; C11D 7/60

(52) U.S. Cl. 166/308.1; 510/188; 134/40

(57) ABSTRACT

A method for performing an oil field service including forming a fluid comprising ammonium salt and exposing an equipment surface to the fluid, wherein the surface retains less residue than if no exposing occurred. A method for preparing for an additional oil field service including forming a fluid comprising ammonium salt, exposing an equipment surface to the fluid wherein the surface retains less residue than if no exposing occurred, and performing an oil field service.

### TECHNICAL FIELD

This invention relates to removing residue in oil field services equipment. More particularly, it relates to using chemicals to flush lines at the completion of a well services treatment.

### BACKGROUND

In the field of hydraulic fracturing there is a continuing effort to use chemicals and processes that offer an improved environmental footprint. A large focus has been placed on methods to limit this risk of accidental release of chemicals into the environment, and to mitigate many risks associated with chemical handling at the wellsite. In addition to new practices for reventment, containment, and capture of fluids at the surface, emphasis is also being placed on the types of chemicals used at the wellsite. In many instances fluid systems that traditionally contained solvents or hydrocarbon-based compounds are reformulated to use more benign products including aqueous brines or even fresh water.

The operation of cleaning the chemical hoses, tanks, pumps, and other surface equipment is necessary at the end of the individual stimulation stages, or at the end of a complete stimulation campaign. Currently, it is common in the oilfield to wash the additive lines with a solvent flush, typically diesel or another petroleum-based product. During this flush process, there is the possibility of spilling this fluid at the wellsite or not fully removing it from the lines after washing, thereby introducing it into the next fluid stage pumped downhole. Substituting these flush fluids with a simple wash of water is often not a viable alternative because some of the chemicals will react with water. An example would be friction reducers which quickly become a thick gel with a high viscosity when water is introduced to the concentrated product. Guar polymer commonly used in slurry form will also have this problem. This gel has a high risk of accumulating in both the lines and in the surface pumping and metering equipment. Formation of a strong gel would significantly impair the flow rate of chemicals that can be delivered during the treatment and could lead to a serious service quality incident.

Many conventional friction reducers and natural water soluble polymer slurries (e.g. guar gum) incorporate an oil-external emulsion or petroleum distillate to aid in surface handling, metering, and dispersion. Some formulations have been made that specifically aim to eliminate the use of BTEX compounds (benzene, toluene, ethylbenze, and xylene) in the fluid package. In recent years, several chemical and service companies now market non-hydrocarbon based friction reducers as environmentally improved systems that are able to achieve similar levels of performance as the conventional fluids. Improved techniques for cleaning the surface lines and systems (e.g. hoses, pumps, transport tanks, metering equipment) after a well service treatment is needed.

### SUMMARY

Embodiments of the invention relate to a method for cleaning surface equipment after use for a stimulation treatment or related operation. Embodiments of the invention relate to a method for performing an oil field service including forming a fluid comprising ammonium salt and exposing an equipment surface to the fluid, wherein the surface retains less residue than if no exposing occurred. Embodiments of the invention relate to a method for preparing for an additional oil field service including forming a fluid comprising ammonium salt, exposing an equipment surface to the fluid wherein the surface retains less residue than if no exposing occurred, and performing an oil field service.

### DETAILED DESCRIPTION

It should be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventor(s) appreciate and understand that any and all data points within the range are to be considered to have been specified, and that the inventor(s) have possession of the entire range and all points within the range.

Embodiments of the current invention relate to the use of a flush fluid which does not contain a petroleum-based solvent and also does not react with water soluble polymer slurries. Use of this flush fluid would reduce the risks of spilling chemicals at the surface, inadvertently pumping these chemicals into the formation, or producing them back at the surface during flowback operations. Embodiments of the present invention relate to the use of a less-hazardous and more effective cleaning agent that can be used in lieu of more environmentally undesirable solvents such as diesel or other hydrocarbon-based fluids that are currently used to clean water sensitive chemicals (e.g. friction reducers and other gelling agents) out of hoses, tanks, metering equipment, or pumps. Embodiments of the present invention pertain to the use of a non-hydrocarbon based fluid system that can be used as a fluid to clean hoses, lines, metering equipment, tanks, or pumps that contain water sensitive materials. Specific equipment that may benefit includes transports or storage tanks containing chemicals, metering pumps, hoses, treatment lines, mixing tubs at blender or hydration units, high pressure pumps, trailers, totes, and/or blenders. At the conclusion of the residue removal, the equipment may be transported and/or used for another oil field service such as hydraulic fracturing, drilling, completions, sand management, enhanced oil recovery, or a combination thereof. Also, this solvent flush fluid can be formulated such that in addition to cleansing properties, it can also be used as low temperature brine that can mitigate the risk of freezing or separation of fluids within the hoses and equipment at the surface.

The following examples further serve to illustrate the invention.

### EXAMPLES

### Example 1

Schlumberger's North and South American Stimulation Client Support (NSA SCS) lab (Sugar Land, Tex., USA) evaluated several brine solutions to determine their efficacy in cleaning transfer lines, totes, or bulk transporters that could potentially contain residual films or small volumes of unused anionic polyacrylamide friction reducer suspended in a brine solution polymer fluid (an anionic polyacrylamide polymer suspended in a brine solution). Two concentrated salt solutions were tested. The first was an ammonium sulfate solution (24% w/w). The second was a brine solution containing 10 to 30 percent ammonium salts. Tests described herein included residue cleaning tests in crystallization dishes as well as in short pieces of laboratory tubing and hose. In addition, compatibility tests and cold weather exposure experiments were performed. The anionic polyacrylamide friction reducer suspended in a brine solution fluid is a polymer-based friction reducer that is suspended in a heavy brine solution. When exposed to fresh water, the polymer forms a strong gel that is not easily broken with conventional oilfield chemicals. This gel has a high risk of accumulating in both the lines and in the surface equipment such as the including Liquid Additive Skid (LAS) pumps. Formation of a strong gel would significantly impair the flow rate of chemicals that can be delivered during the treatment and could lead to a serious service quality incident. The NSA-SCS lab launched an internal investigation to evaluate several water-based brine solutions to determine their efficacy in cleaning transfer lines, totes, or bulk transporters that contain residual films or small volumes of unused anionic polyacrylamide friction reducer suspended in a brine solution polymer fluid.

Two concentrated salt solutions were tested. The first was an ammonium sulfate solution (24% w/w). The second was a brine solution containing 10-30 percent ammonium salt. The salt content and concentrations in this second solution are similar to the stock solution used in the manufacture of the anionic polyacrylamide friction reducer suspended in a brine solution product; however, the brine solution does not contain certain reagents or reaction products found in the polymer-containing product. Several test methods were employed to evaluate the cleaning/flushing properties of the brines. The first tests were residue tests in glass crystallization dishes. Additional experiments were performed in short pieces of laboratory tubing and hose. In addition, compatibility tests and cold weather exposure experiments were performed.

### Experimental Procedures

### Fluid Preparation:

The water was obtained from the municipal tap water system (Sugar Land, Tex.) Both brine fluid systems were tested as provided by the supplier. The 24% (w/w) ammonium sulfate solution from Fritz Industries (Mesquite, Tex.) was a clear amber solution provided in several 1 L containers. The samples were provided from lot number 092410 and were sampled on the 27 Sep. 2010. They were received in the NSA-SCS laboratory on the 29 Sep. 2010. The brine solution containing 10 to 30 percent ammonium salts was received directly from Nalco (Sugar Land, Tex.) and was a clear and colorless solution. Approximately 2 L was received on the 30 Sep. 2010. Both solutions were free-flowing liquids with no solids. Although the viscosity of the solutions was not measured, both fluids poured easily from the sample bottles and acted as low viscosity fluids similar to water. A summary of the brine products is provided below in Table 1:

TABLE 1
Summary of the brine solutions evaluated

| Product | Manufacturer | Chemistry | Appearance | Density | pH |
|---|---|---|---|---|---|
| Ammonium | Fritz | Ammonium | Clear, Amber | 1.14 | 5.0-5.5 |
| Sulfate | | Sulfate (24%) | | | |
| brine solution | Nalco | 10-30% | Clear, colorless | 1.2 | 4.0 |
| containinng 10 | | ammonium | | | |
| to 30 percent | | salts | | | |
| ammonium salts | | | | | |

### Crystallization Dish Residue Test:

Several flat crystallization dishes (Pyrex Brand, model 3140) measuring 90 mm in diameter and 50 mm in height were used to evaluate the different brines. Approximately 5 mL of anionic polyacrylamide friction reducer suspended in a brine solution was loaded into the base of each dish and then the samples were gently swirled by hand to ensure full coverage of the flat surface. After loading the sample, a 5 mL aliquot of the brine solution was added to the dish, making a 1:1 product ratio. Care was taken to slowly add the brine in the center of the tray, and with minimal force as to not pre-maturely wash or flush the polymer from the surface of the glass. The dish and its contents were then gently swirled by hand for approximately 30 seconds, taking care to keep most of the liquid in the flat portion of the dish and not attempting to coat the vertical walls. No spatulas or other stirring devices were used to distribute the material. The fluid was then discarded into a secondary container. Some tests were performed with an additional wash of 5 mL of the brine solution, which was then discarded into the secondary container.

The tendency for gel formation was tested on the remaining residue in the dish after its contents were poured out into a secondary container. The surface was left relatively wet and no spatulas, sponges or towels were used to wipe or otherwise clean the surface. Immediately after emptying the free-flowing liquid from the glass dish, 5 mL of fresh water was applied and the dish was then examined for the presence of gel.

### Hose Residue Test

Several lengths of laboratory hose were used in a similar fashion as the glass residue tests on the crystallization dishes. Several sections of short hosing (˜15 inches long) were chosen from the selection of hoses available in the lab. Testing the brine flush in hoses was conducted by loading the tubing with the fluids. Next, the fluids were mixed by inverting the tubing. Then, flow testing the tubing afterwards and checking for evidence of gel formation was completed. For most tests the tubing was filled with 20 mL of anionic polyacrylamide friction reducer suspended in a brine solution and the ends were capped with gloves and the solution was spread evenly on the walls of the tubing. 20 mL of the brine solution was then added to the tubing and the system was mixed by repeatedly inverting the tubing 4-5 times. After fully mixing, the fluid was emptied from the tube into a secondary container. The tube was then rinsed with 10 mL of the brine solution and the fluid was then emptied into a secondary container. The tube was then flushed with fresh water and signs for gel formation were examined.

In a separate test, a section of Tygon tubing (Masterflex brand) was used with a peristaltic pump. The anionic polyacrylamide friction reducer suspended in a brine solution was circulated through the tubing. Once filled with anionic polyacrylamide friction reducer suspended in a brine solution, the suction side of the hose was switched to the brine solutions. After at least 1.5 tubing volumes were pumped, the suction side of the hose was switched to fresh water. The tubing and effluent were examined for signs of gel formation.

### Freeze Tests

Several samples of fresh brines as well as a diluted ammonium sulfate solution (18% w/w) were placed in several temperature controlled coolers and the samples were checked periodically for signs of precipitation or salt separation, as well as for freezing. All samples were placed in HDPE plastic bottles ranging in size from 100 to 500 mL.

### Results and Discussion

### Crystallization Dish Residue Test:

Tests with 1:1 mixtures of the anionic polyacrylamide friction reducer suspended in a brine solution polymer and either brine solution resulted in gel formation when fresh water was added to the system. As a result of these tests, it was determined that a wash protocol would need to be developed to first flush the lines and then test the gelling tendency of the residue left on the container or hose surface. Several residue tests were performed with the crystallization dishes as shown in Table 2 below:

TABLE 2
Summary of residue tests performed in the crystallization dish.

| | | ANIONIC POLYACRYLAMIDE | | | |
|---|---|---|---|---|---|
| | | FRICTION REDUCER | 1^{st} Brine Wash | 2^{nd} Brine Wash | Results/Comments |
| Test | Brine | SUSPENDED IN A BRINE | (combined | (after disposal | (after addition of |
| # | Tested | SOLUTION loading | w/polymer) | of 1^{st} wash) | 5 mL fresh water) |
| R1. | None | 5 mL | None | None | Strong gelling |
| R2. | Ammonium | 5 mL | 5 mL | None | Moderate gelling |
| | Sulfate 24% | | | | |
| R3. | Ammonium | 5 mL | 5 mL | None | Moderate gelling |
| | Sulfate 10- | | | | |
| | 30% | | | | |
| R4. | Ammonium | 5 mL | 5 mL | 5 mL | No significant |
| | Sulfate 24% | | | | gelling |
| R5. | Ammonium | 5 mL | 5 mL | 5 mL | Slight gelling |
| | Sulfate 10- | | | | |
| | 30% | | | | |

### Hose Residue Test

As a result of the testing, it was determined that wash protocol that involves an initial flush followed by a second wash would be necessary to mitigate the risk of gel formation when fresh water is introduced to the system. Several tests were then performed in the cut tubing samples to confirm this effectiveness of the wash sequence. Acceptable cleaning (i.e. lack of gel formation) was obtained when using either brine solution with any of the three tubing segments. Similarly, the tests with the peristaltic pump were successful and no gel formation was noted when testing with either brine solution.

### Freeze Tests

Undiluted samples of either brine solution as well as the diluted ammonium sulfate solution (18% w/w) were prepared and tested at 41 deg F. (5 deg C.), 10 deg F. (−12 deg C.) and −4 deg F. (−20 deg C.) for 96 hours. The results of the test are shown below in Table 3.

TABLE 3
Results of the freezer tests with the brine solutions.

| Test | Brine | | | |
|---|---|---|---|---|
| # | Tested | Temperature | 24 hours | 96 hours |
| F1. | Ammonium | 41 deg F. | No separation, no freezing | No separation, no freezing |
| | Sulfate 18% | (5 deg C.) | | |
| F2. | Ammonium | | No separation, no freezing | No separation, no freezing |
| | Sulfate 24% | | | |
| F3. | Ammonium | | No separation, no freezing | No separation, no freezing |
| | Sulfate 10- | | | |
| | 30% | | | |
| F4. | Ammonium | 10 deg F. | No separation, no freezing | No separation, no freezing |
| | Sulfate 18% | (−12 deg C.) | | |
| F5. | Ammonium | | Thin slush layer formed on | ⅓ frozen. Solid material. |
| | Sulfate 24% | | top, easily broken with | The fluid solution is clear |
| | | | agitation. | with no precipitant |
| F6. | Ammonium | | Moderate frozen region on | ½ frozen, Solid material. |
| | Sulfate 30- | | top. Can be partially | The fluid solution is clear |
| | 30% | | broken with agitation. | with no precipitant |
| F7. | Ammonium | −4 deg F. | Frozen solid, no liquid. | Frozen solid, no liquid. |
| | Sulfate 18% | (−20 deg C.) | | |
| F8. | Ammonium | | Frozen solid, no liquid. | Frozen solid, no liquid. |
| | Sulfate 24% | | | |
| F9. | Ammonium | | Frozen solid, no liquid. | Frozen solid, no liquid. |
| | Sulfate 10- | | | |
| | 30% | | | |

No tests were run at temperatures between 10 deg F. and 41 deg F., therefore the minimum temperature for storing the brine solutions is not completely known. Until further tests are performed it is not recommended to store the undiluted brine samples at temperatures lower than 32 deg F. (0 deg F.) as this is the freezing point of fresh water.

The 24% ammonium sulfate and the brine solution containing 10 to 30 percent ammonium salts brine solutions were found to be fully miscible with anionic polyacrylamide friction reducer suspended in a brine solution fluids. No incompatibilities, precipitates, or reactions were noted. Neither brine solution prevented gel formation by simple dilution of the polymer in 1:1 ratios; however, both were able to wash the polymer from glass or plastic surfaces to an acceptable level such that fresh water could be applied to the surface without significant gel formation. Both brine solutions remained in solution when kept at 41 deg F. (5 deg C.) for 96 hours but showed significant tendencies for freezing at 10 deg F. (−12 deg C.).

### CONCLUSIONS

1. The 24% ammonium sulfate and the brine solution containing 10 to 30 percent ammonium salts brine solutions are fully miscible with anionic polyacrylamide friction reducer suspended in a brine solution fluids. No incompatibilities, precipitates, or reactions were noted.
2. The residue that remained on a glass dish after a product wash (polymer-brine ratio of 1:1) left a film that was water sensitive and produced a noticeably thick gel layer when exposed to fresh water.
3. A second wash with fresh brine on the glass surface produced a residue that was tolerant of fresh water. The samples treated with ammonium sulfate (24% w/w) did not form a strong gel when exposed to water. The samples treated with the brine solution containing 10 to 30 percent ammonium salts produced a thin gel layer; however the volume of gel is significantly reduced as compared to the volume produced in a baseline sample.
4. Residue tests performed in laboratory hoses demonstrated that with either brine, a 1:1 product wash followed by a final rinse with the fresh brine solution provided adequate cleaning properties. This regiment allowed the equipment to be later washed with fresh water without any issues.
5. Each brine solution remained in solution when kept at 41 deg F. (5 deg C.) for 96 hours. Both products had partial freezing at 10 deg F. (−12 deg C.) after 24 hours exposure. After 96 hours at 10 deg F. (−12 deg C.) the 24% ammonium sulfate sample was ⅓ frozen and the brine solution containing 10 to 30 percent ammonium salts brine was ½ frozen. All brine samples were completely frozen after 24 hours at −4 deg F. (−20 deg C.).

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method for performing an oil field service, comprising:
forming a fluid comprising ammonium salt; and
exposing an equipment surface to the fluid,
wherein the surface retains less residue than if no exposing occurred.

2. The method of claim 1, wherein the ammonium salt is at a concentration of 10 to 30 percent.

3. The method of claim 1, wherein the ammonium salt is ammonium sulfate.

4. The method of claim 1, wherein the exposing the surface comprises flushing lines.

5. The method of claim 1, wherein the residue comprises friction reducer.

6. The method of claim 1, wherein the fluid has a temperature of at least about −10° C.

7. The method of claim 1, wherein the fluid has a temperature of at least about −20° C.

8. The method of claim 1, wherein the exposing does not comprise forming precipitates.

9. The method of claim 1, wherein the equipment surface includes a surface of a pump, tubular, hoses, lines, metering equipment, tanks, transports, storage tanks, metering pumps, mixing tubs, blender or hydration units, trailers, totes, and/or blenders.

10. A method for preparing for an additional oil field service, comprising:
forming a fluid comprising ammonium salt;
exposing an equipment surface to the fluid,
wherein the surface retains less residue than if no exposing occurred; and
performing an oil field service.

11. The method of claim 10, wherein the ammonium salt is at a concentration of 10 to 30 percent.

12. The method of claim 10, wherein the ammonium salt is ammonium sulfate.

13. The method of claim 10, wherein the exposing the surface comprises flushing lines.

14. The method of claim 10, wherein the residue comprises friction reducer.

15. The method of claim 10, wherein the fluid has a temperature of at least about −10° C.

16. The method of claim 10, wherein the fluid has a temperature of at least about −20° C.

17. The method of claim 10, wherein the exposing does not comprise forming precipitates.

18. The method of claim 10, wherein the equipment surface includes a surface of a pump, tubular, hoses, lines, metering equipment, tanks, transports, storage tanks, metering pumps, mixing tubs, blender or hydration units, trailers, totes, and/or blenders.

19. The method of claim 10, wherein the service comprises hydraulic fracturing, drilling, completions, sand management, enhanced oil recovery, or a combination thereof.
